(19) United States
(12) Patent Application Publication
(10) Pub. No.: US 2026/0357901 A1
(43) Pub. Date: Nov. 12, 2026

(54) FLOW CONTROL DEVICE FOR CHUTES

(71) Applicant: Hargrove and Associates, Inc., Mobile, AL (US)

(72) Inventors: Dorcel Andrew Knapp, Crown Point, IN (US); Byron Williams, Laurens, SC (US)

(21) Appl. No.: 19/201,690

(22) Filed: May 7, 2025

(51) Int. Cl. F16K 3/06; B65G 43/00; F16K 3/02

(52) U.S. Cl. CPC F16K 3/06; B65G 43/00; F16K 3/0254; F16K 3/029

(57) ABSTRACT

An adjustable flow control device for reducing the flow rate of bulk materials conveyed through chutes and a method of using the device to control the flow rate are provided. The device has one or more deflector plates positioned within a flow path of the bulk material within the chute. The angular position of the deflector plates can be manually adjusted by rotating a handle on the outside of the chute. A fastener may be used to selectively retain the handle in a fixed position, which then retains the deflector plate in a fixed angular position. As the bulk material flows through the device, the material contacts the deflector plates, which redirects the flow of the material and thus reduces the flow rate.

### FIELD OF THE DISCLOSURE

The present disclosure relates to flow control devices for chutes, and more particularly to an adjustable flow control device for reducing the flow rate of bulk materials conveyed through chutes.

### BACKGROUND

Chutes are commonly used in various industries to convey dry solid bulk materials such as granular, aggregate, powdered, or particulate materials. These chutes are typically positioned vertically or at an angle of incline to utilize gravity flow to facilitate the downward flow of materials, which can be an efficient method for material handling in many applications. However, the reliance on gravity can lead to high-velocity material flow, potentially causing issues during the conveying process. One concern associated with high-velocity material flow through chutes is the generation of dust. As materials descend rapidly through the chute, particles can become airborne, creating dust clouds. This dust formation can have several negative consequences. In some cases, particularly with certain types of grains or other combustible materials, the dust may pose explosion risks. Additionally, elevated levels of airborne particulates in the surrounding environment can create health hazards for workers or individuals in the vicinity of the chute system.

Given these potential issues, there is interest in methods to control and reduce the flow rate of materials that gravity flow through chutes. By moderating the speed at which materials descend, it may be possible to minimize dust formation and its associated risks. However, implementing flow control in existing chute systems can present challenges. Retrofitting older installations with flow control devices may be complex, potentially requiring significant modifications to the chute structure or the integration of sophisticated control mechanisms. There is a need for simple, cost-effective solutions that can be easily incorporated into both new and existing chute systems to regulate material flow. Ideally, such solutions would allow for adjustable control to accommodate different types of materials or varying flow requirements. Additionally, devices that can be installed with minimal alterations to the existing chute structure would be beneficial for many industrial applications. As industries continue to prioritize safety and efficiency in material handling processes, advancements in flow control technology for chutes remain an area of ongoing development and improvement.

### SUMMARY

In one aspect, a flow control device for reducing the flow rate of bulk materials conveyed through chutes and a method of using the device are provided. One or more of the flow control devices may be installed within a chute through which bulk materials, such as grains or any similar types of granular or aggregate materials, are conveyed by gravity flow. The chutes may be disposed in a vertical position or at an inclined angle that allows gravity flow. The flow control device comprises a one or more deflector plate assemblies that are installed on the chute. Each deflector plate assembly comprises a deflector plate disposed within an interior of the chute and a handle disposed on an exterior of the chute for manually adjusting an angular position of the deflector plate relative to the flow path of the bulk material through the chute. The flow control device further comprises a fastener configured to selectively retain the handle in a fixed position, thereby also retaining the deflector plate in a fixed position in the flow path. In a preferred embodiment, each flow control device comprises two deflector plate assemblies installed on opposing sides of a section of the chute so that the bulk material flows between two opposing deflector plates. The angular position of each plate may be independently adjusted to achieve a desired reduction of the downward flow rate of the granular material. As the bulk material falls downward through the flow control device, the bulk material contacts one or both of the deflector plates, which deflect and thus slow the flow of the bulk material through the chute.

The fastener secures the handle in a desired position so that pressure exerted against the deflector plate by the flow of bulk material does not cause the angular position of the deflector plate to change during normal use after the angular position is set. In a preferred embodiment, to provide additional structural support to the deflector plate to maintain a fixed angular position of the deflector plate, the flow control device further comprises a deflector plate support assembly for each deflector plate. The deflector plate support assembly comprises a rotatable support rod attached to the chute and a support arm attached to the support rod. The support arm is slidably attached to the deflector plate so that an attachment point between the support arm and the deflector plate can be maintained when the angular position of the deflector plate is adjusted. The deflector plate support assembly comprises a retaining device configured to lock the support rod in a fixed rotational position once the deflector plate is set in a desired angular position and the handle is secured in place to prevent angular movement of the deflector plate.

The flow control device may be retrofitted to an existing chute with minimal modification of the chute. A section of a wall on one side of the chute may be removed and replaced with the flow control device, which may include a cover plate that replaces the section of the chute wall that is removed. The cover plate preferably includes a closable door that can be opened to visually check the angular position of the deflector plates and also to perform any necessary maintenance on the device after installation. The device preferably does not include any type of automated or remote actuating devices for adjusting the position of the deflector plates, and all adjustments are performed by a user manually rotating the handles to change the positions of the deflector plates and then locking the handles in the desired position.

The foregoing summary has outlined some features of the device of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purposes of the device disclosed herein. Those skilled in the pertinent art should also realize that such equivalent designs or modifications do not depart from the scope of the device of the present disclosure.

### DESCRIPTION OF THE DRAWINGS

These and other features, aspects, and advantages of the present invention will become better understood with regard to the following description, appended claims, and accompanying drawings where:

FIG. 1 shows a perspective view of a device for controlling the flow of bulk material through chutes in accordance with the present disclosure.

FIG. 2 shows a perspective view of a chute casing for a flow control device for chutes in accordance with the present disclosure.

FIG. 3 shows a bottom perspective view of a flow control device installed in a portion of a chute in accordance with the present disclosure.

FIG. 4 shows a top perspective view of a flow control device installed in a portion of a chute in accordance with the present disclosure.

FIG. 5 shows a side view of a flow control device installed in a portion of a chute in accordance with the present disclosure.

FIG. 6 shows a perspective view of two flow control devices installed in series in a chute in accordance with the present disclosure.

FIGS. 7A-7E each show a side view of two flow control devices installed in series in a vertical chute in varying flow control configurations in accordance with the present disclosure.

FIG. 7F shows a side view of two flow control devices installed in series in a chute disposed at an inclined angle in accordance with the present disclosure.

FIG. 8 shows a top perspective view of a cover for a flow control device for chutes in accordance with the present disclosure.

FIG. 9 shows a bottom perspective view of a cover for a flow control device for chutes in accordance with the present disclosure.

FIG. 10 shows a side perspective view of an adjustable deflector plate for a flow control device for chutes in accordance with the present disclosure.

FIG. 11 shows a side perspective view of an adjustable deflector plate for a flow control device for chutes in accordance with the present disclosure.

FIG. 12 shows a cross-sectional view of a handle assembly for adjusting the position of a deflector plate for a flow control device for chutes in accordance with the present disclosure.

FIG. 13 shows a perspective view of a locking mount for a handle for adjusting the position of a deflector plate for a flow control device for chutes in accordance with the present disclosure.

FIG. 14 shows a perspective view of a handle for adjusting the position of a deflector plate for a flow control device for chutes in accordance with the present disclosure.

FIG. 15 shows a top view of a handle for adjusting the position of a deflector plate for a flow control device for chutes in accordance with the present disclosure.

FIG. 16 shows a perspective view of a support arm assembly for an adjustable deflector plate for a flow control device for chutes in accordance with the present disclosure.

FIG. 17 shows a side view of a support arm assembly for an adjustable deflector plate for a flow control device for chutes in accordance with the present disclosure.

FIG. 18A shows a side view of a support base for a support arm assembly for an adjustable deflector plate for a flow control device for chutes in accordance with the present disclosure.

FIG. 18B shows a cross-sectional view of a support base for a support arm assembly for an adjustable deflector plate for a flow control device for chutes in accordance with the present disclosure.

FIG. 19 shows a perspective view of an alternative embodiment of a device for controlling the flow of bulk material through chutes in accordance with the present disclosure.

### DETAILED DESCRIPTION

In the Summary above and in this Detailed Description, and the claims below, and in the accompanying drawings, reference is made to particular features, including method steps, of the invention as claimed. In the present disclosure, many features are described as being optional, e.g. through the use of the verb “may.” For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features, or with all three of the three possible features. It is to be understood that the disclosure in this specification includes all possible combinations of such particular features. For example, where a particular feature is disclosed in the context of a particular aspect or embodiment, or a particular claim, that feature can also be used, to the extent possible, in combination with/or in the context of other particular aspects or embodiments, and generally in the invention as claimed.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The present invention provides a flow control device for controlling the flow rate of bulk materials conveyed through chutes and a method of using the device in accordance with the independent claims. Preferred embodiments of the invention are reflected in the dependent claims. The claimed invention can be better understood in view of the embodiments described and illustrated in the present disclosure, viz. in the present specification and drawings. In general, the present disclosure reflects preferred embodiments of the invention. The attentive reader will note, however, that some aspects of the disclosed embodiments extend beyond the scope of the claims. To the respect that the disclosed embodiments indeed extend beyond the scope of the claims, the disclosed embodiments are to be considered supplementary background information and do not constitute definitions of the invention per se.

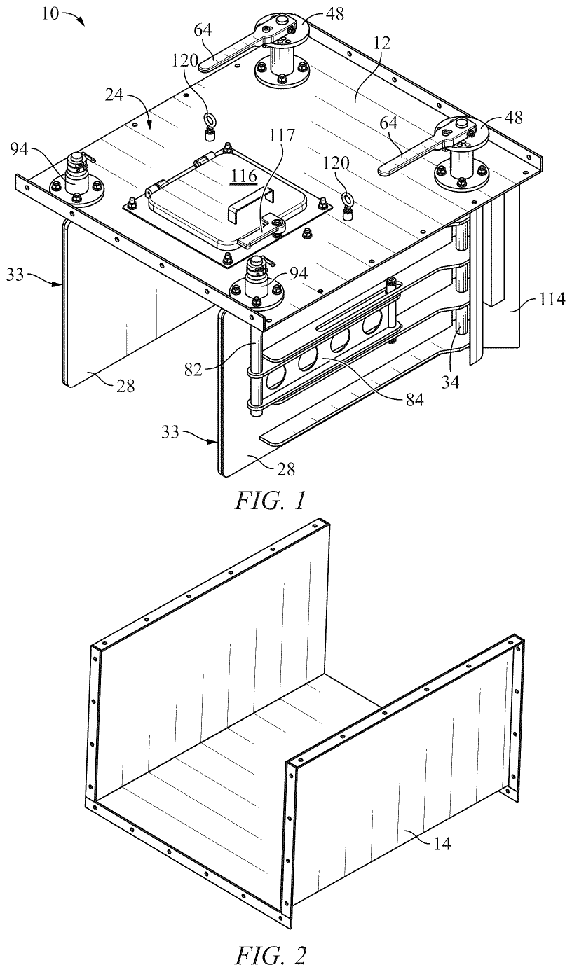

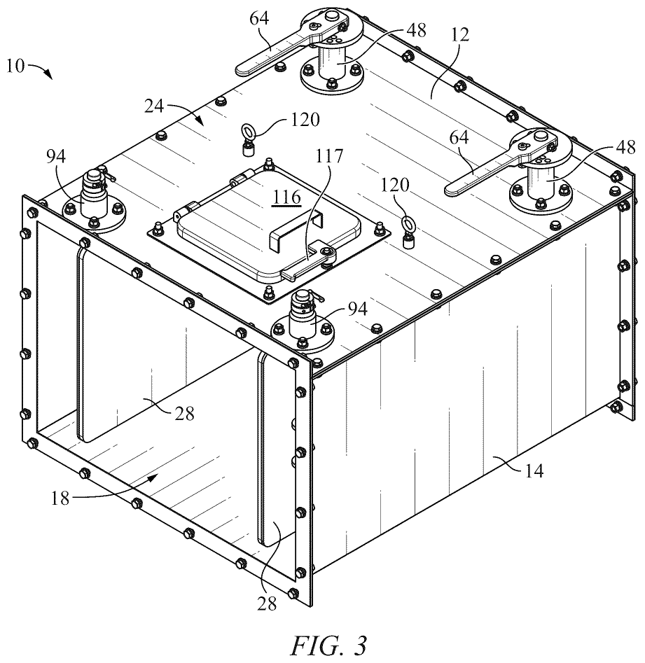

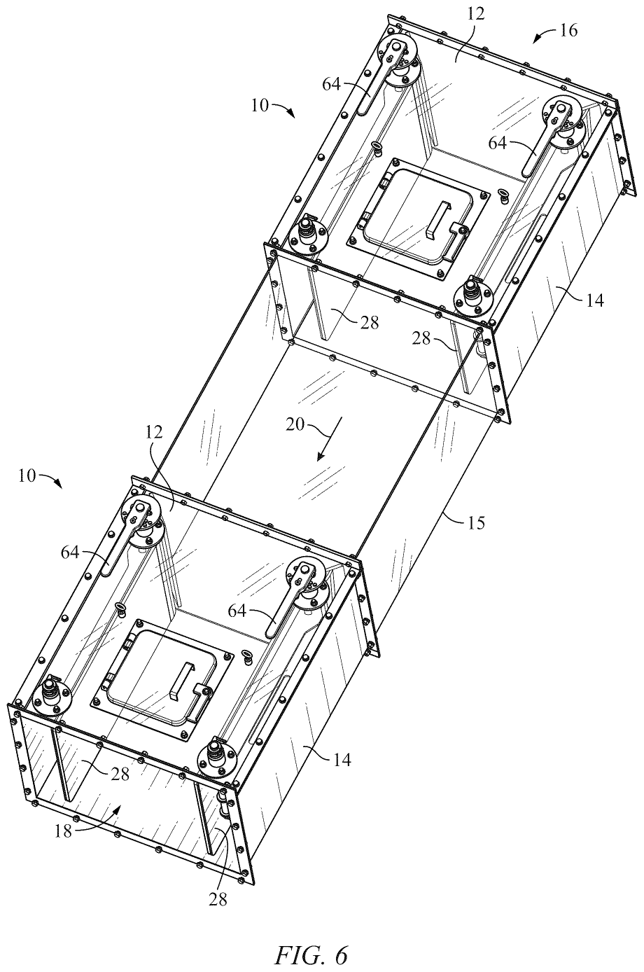

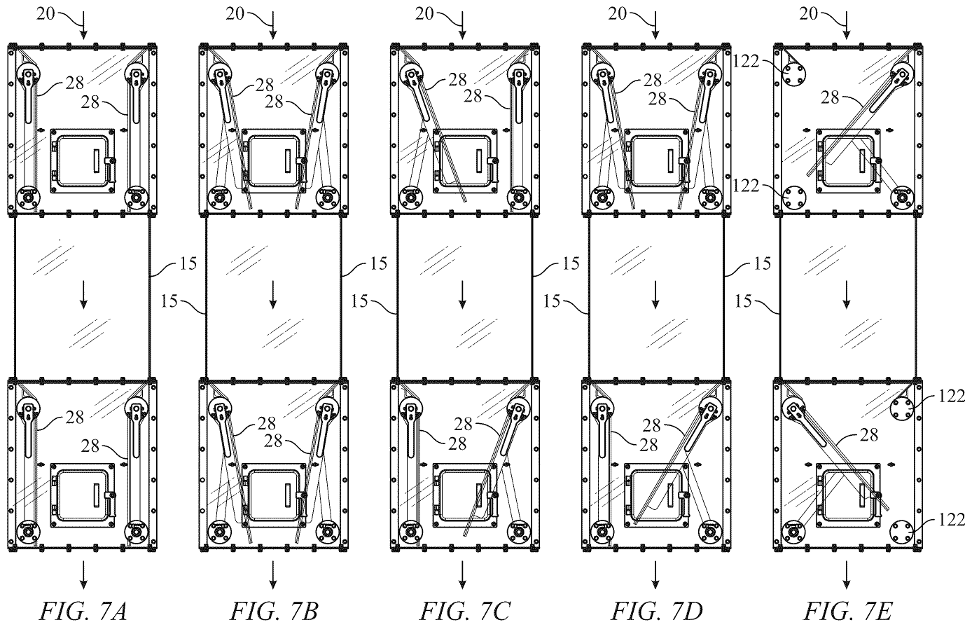

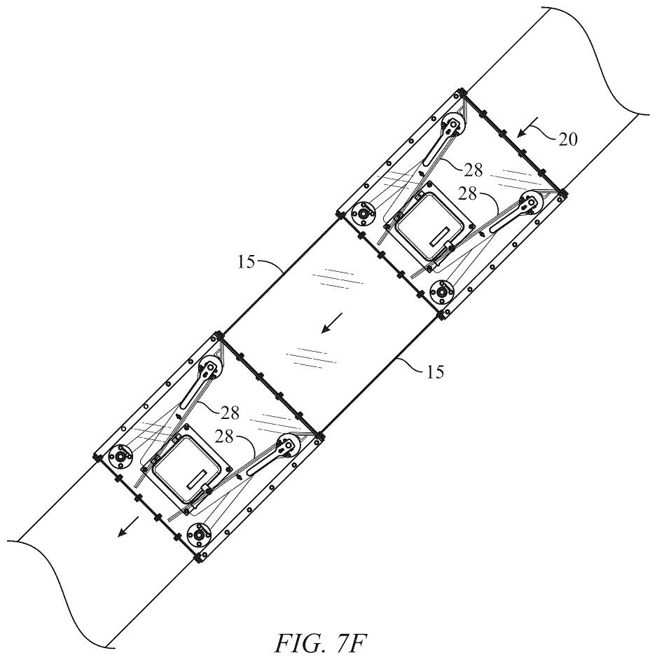

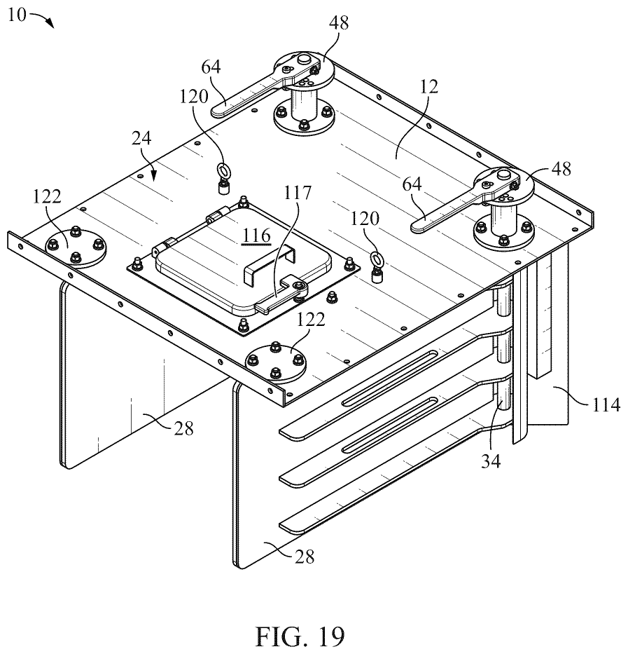

In one aspect, a flow control device 10 for reducing the flow rate of bulk materials conveyed through a chute 15 is provided. One or more of the flow control devices 10 may be installed within the chute 15 through which bulk materials are conveyed by gravity flow. In one preferred embodiment, as shown in FIGS. 7A-7E, the chute 15 may be disposed in a generally vertical position. In other embodiments, as best seen in FIG. 7F, the chute 15 may be disposed at an inclined angle. The chute 15 preferably has a rectangular structure that is enclosed on all sides around a flow path 20 through the chute 15. FIGS. 1 and 19 show a flow control device 10 separate from a chute 15, and FIGS. 3-5 show a flow control device 10 installed within a casing 14 that may form a portion of a chute 15. Each of FIGS. 6-7F shows two flow control devices 10 installed in series within a section of a chute 15. Bulk materials that may be conveyed through a chute 15 utilizing one or more flow control devices 10 include, but are not limited to, grains, cereals, or other foods such as salt, sugar, or flour, chemicals, aggregate material such as sand, gravel, or stone, organic material such as wood chips, or any similar types of materials that are in the form of granules, particulates, powders, or any other type of flowable solid material, such as coal, cement, limestone, and alumina.

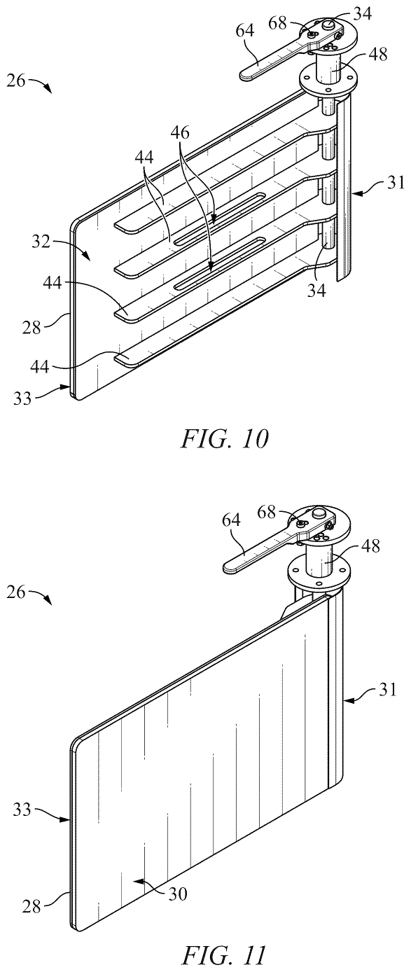

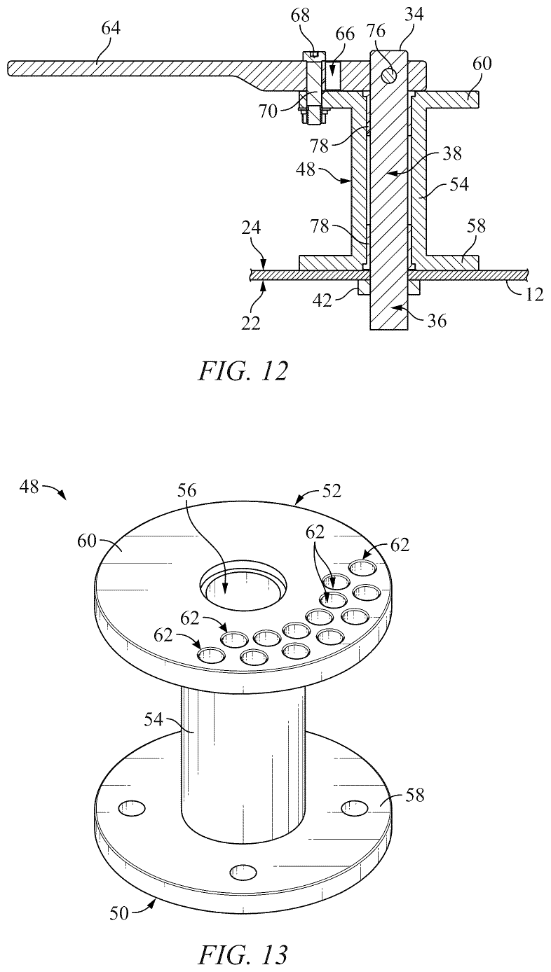

Each flow control device 10 comprises a one or more deflector plate assemblies 26 that are installed on the chute 15. FIGS. 10 and 11 show a deflector plate assembly 26 removed from the device 10, and FIGS. 12-15 show components of a deflector plate assembly 26. Each deflector plate assembly 26 comprises a deflector plate 28 disposed within an interior of a chute 15 and a handle 64 disposed on an exterior of the chute 15 for manually adjusting an angular position of the deflector plate 28 relative to a flow path 20 of the bulk material being conveyed through the chute 15. The handle 64 is configured to lock in varying fixed positions to control the angular positioning of the deflector plate 28. Preferably, each flow control device 10 further comprises a fastener 68 configured to selectively retain the handle 64 in a fixed position, thereby retaining the deflector plate 28 in a fixed angular position relative to the flow path 20. In a preferred embodiment, as best seen in FIGS. 1 and 6, each flow control device 10 comprises an opposing pair of deflector plate assemblies 26 installed on opposing sides of a section of the chute 15 so that the bulk material flows between an opposing pair of deflector plates 28. The angular position of each deflector plate 28 may be independently adjusted by separate handles 64. The two opposing deflector plates 28 may work in combination to achieve a desired reduction of the downward flow rate of the bulk material. As the bulk material falls downward through the flow control device 10, the bulk material contacts one or both of the deflector plates 28, which deflect and thus slow the flow of the bulk material through the chute 15. Separate fasteners 68 may be used to secure each handle 64 in a desired position so that pressure exerted against each of the deflector plates 28 by the flow of bulk material does not cause the angular position of the deflector plates 28 to change during normal use after the angular position is set.

The flow control device 10 may be installed on any chute 15 and is preferably designed so that the device 10 may be retrofitted to an existing chute 15 with minimal modification of the chute 15. FIG. 1 shows the flow control device 10 without a chute 15. FIG. 2 shows a casing 14 to which the device 10 may be attached using fasteners such as bolts, and FIG. 3 shows the device shown in FIG. 1 attached to the casing 14. The casing 14 shown in FIG. 2 may represent a portion of an existing chute 15 on which the device 10 may be installed in-situ. The flow control device 10 includes a cover plate 12 and at least one deflector plate assembly 26 attached to the cover plate 12. The casing 14 preferably has three rectangular sides. The cover plate 12 and casing 14 may have flanges to facilitate attachment of the cover plate 12 to the casing 14 to form a rectangular enclosure having four sides, which may form a portion of the chute 15. The flanges of the cover plate 12 and casing 14 may also facilitate attachment of the flow control device 10 to adjacent portions of the chute 15, as best seen in FIG. 6. FIGS. 6-7F show the cover plate 12 and other portions of the chute 15 as being transparent to show components of the device 10 disposed within the interior of the chute 15, though these components are typically made of an opaque material, such as metal.

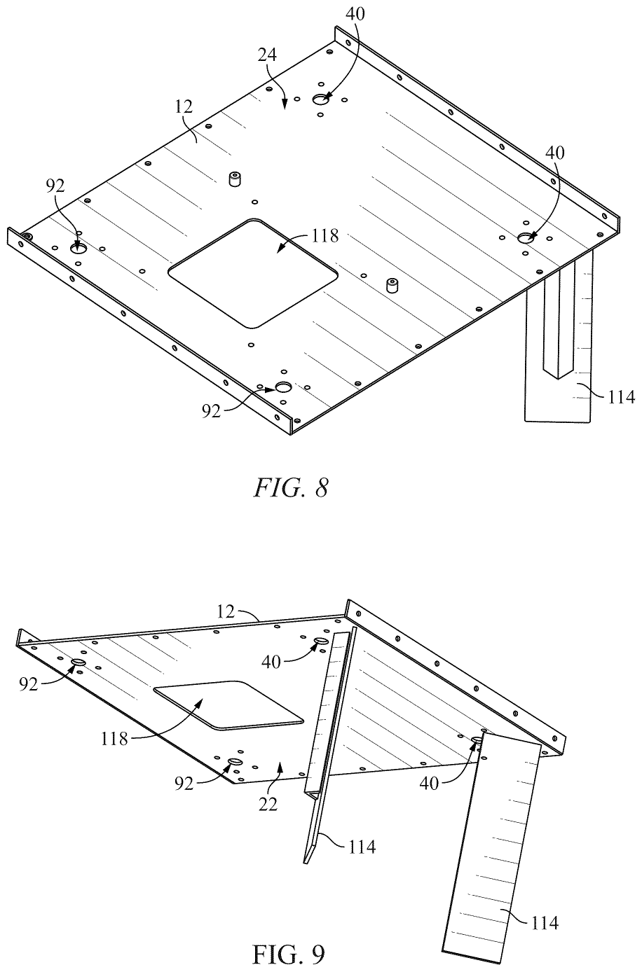

To retrofit the flow control device 10 to an existing chute 15, a section of a side wall on one side of a rectangular chute 15 may be removed and replaced with the flow control device 10 shown in FIG. 1. In this case, the cover plate 12 may be used to replace the section of the side wall of the chute 15 wall that is removed for installation of the device 10, and the casing 14 shown in FIG. 3 may be a portion of an existing chute 15. Thus, the casing 14 shown in FIG. 2 may represent three sides of an existing rectangular chute 15 with one side removed for attachment of the cover plate 12 to the casing 14 in-situ. Alternatively, the casing 14 may be installed on the device 10, and the device 10 as shown in FIG. 3 may be used to replace a section of an existing chute 15 with the casing 14 and cover plate 12 thus forming portions of the chute 15 after installation. In new installations, sections of a chute 15 may be fastened to one or both ends of the device 10 as shown in FIG. 3. The cover plate 12 preferably includes a closable door 116 that can be opened to visually check the angular position of the deflector plates 28 and also to perform any necessary maintenance on the device 10 or portions of the chute 15 after installation. The door 116 may have a handle for opening and closing the door 116 and a latch 117 for securing the door 116 in a closed position. As best seen in FIGS. 8 and 9, the cover plate 12 is preferably a generally flat plate that has openings extending through the plate 12 for installation of various components, including a relatively large opening 118 that is covered by the door 116 when the door 116 is closed. The cover plate 12 may also include rings 120 for attaching straps or chains to lift the device 10 for installation or removal using a hoist or crane.

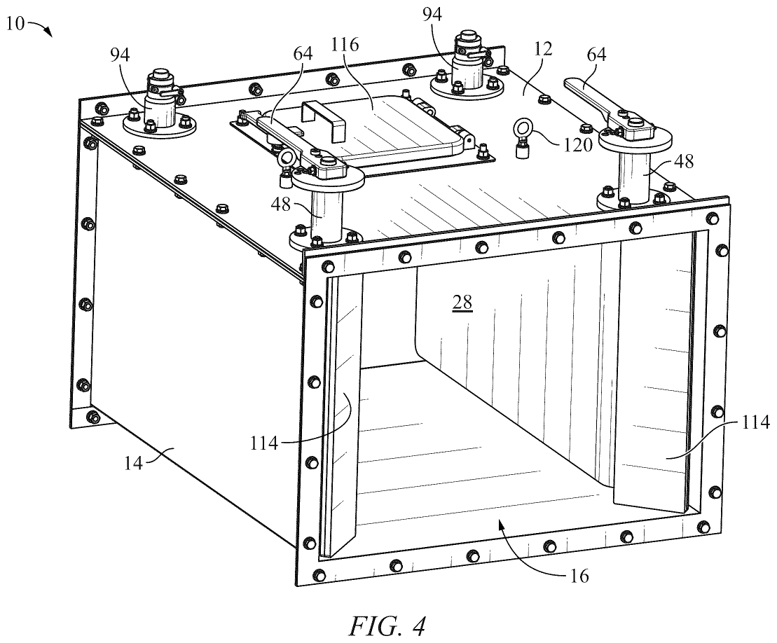

As best seen in FIGS. 3 and 4, after installation of the casing 14 onto the device 10, the enclosure formed by the cover plate 12 and casing 14 preferably has four sides that are aligned with four sides of walls of the chute 15 that extend in one or both directions from the enclosure. Thus, one of the four sides of the enclosure that forms a portion of the chute 15 may be defined by the cover plate 12. The enclosure has an open inlet end 16, as best seen in FIG. 4, and an open outlet end 18, as best seen in FIG. 3. When installed on a vertical or inclined chute 15, the open inlet end 16 is at the upper end of the device 10, and the open outlet end 18 is at the lower end of the device 10. The cover plate 12 has an interior side 22, which is the side facing inwardly toward the flow path 20 within the interior of the chute 15, and an exterior side 24, which is the side facing outwardly.

Each deflector plate assembly 26 comprises an adjustment rod 34 extending through an adjustment rod opening 40 in the cover plate 12. As best seen in FIG. 12, a first portion 36 of the adjustment rod 34 is disposed on the interior side 22 of the cover plate 12, and a second portion 38 of the adjustment rod 34 is disposed on the exterior side 24 of the cover plate 12. The adjustment rod 34 is rotatable within the adjustment rod opening 40. The adjustment rod 34 is disposed in a position in which the adjustment rod 34 is generally perpendicular to the cover plate 12. The deflector plate 28 is attached to the first portion 36 of the adjustment rod 34 so that the deflector plate 28 is disposed on the interior side 22 of the cover plate 12 in a position in which the deflector plate 28 is generally perpendicular to the cover plate 12. Each deflector plate 28 has an interior side 30, as best seen in FIG. 11, and an exterior side 32, as best seen in FIG. 10. The interior side 30 of each deflector plate 28 preferably has a generally flat surface that faces inwardly toward the flow path 20 of the bulk material within the chute 15, which preferably extends between the opposing pair of deflector plates 28 and through the rectangular casing 14 from the open inlet end 16 to the open outlet end 18. The interior side 30 of each deflector plate 28 contacts and deflects the flow of bulk material to reduce and control the flow rate.

In a preferred embodiment, a proximal end 31 of each deflector plate 28 is fixedly attached to each adjustment rod 34 along a length of the first portion 36 of the adjustment rod 34 so that the deflector plate 28 is generally parallel to an axis of rotation defined by the adjustment rod 34. The angular position of the deflector plate 28 may be adjusted through rotation of the adjustment rod 34, which may move a distal end 33 of the deflector plate 28 into the flow path 20 or outward from a center of the flow path 20 and toward the casing 14 or other portion of a wall of the chute 15, depending on the direction of rotation of the adjustment rod 34. The proximal end 31 of the deflector plate 28 is disposed at an upstream end of the deflector plate 28 relative to the flow path 20, and the distal end 33 of the deflector plate 28 is disposed at a downstream end of the deflector plate 28. The proximal end 31 of the deflector plate 28 may curve around the adjustment rod 34 to minimize or prevent bulk material from directly contacting the adjustment rod 34 and from flowing on the exterior side 32 of the deflector plate 28. In a preferred embodiment, as best seen in FIG. 9, a pair of opposing guide plates 114 may be attached to the interior side 22 of the cover plate 12 and extend perpendicularly from the interior side 22 of the cover plate 12. As best seen in FIGS. 4 and 7A-7F, the guide plates 114 are disposed at the inlet end 16 of the device 10 and are configured to guide the bulk material into the flow path 20 to prevent any of the bulk material from flowing between the deflector plates 28 and an interior wall of the casing 14 or other portion of the chute 15. There is preferably a small gap between the guide plate 114 and the curved portion of the proximal end 31 of the deflector plate 28 to allow the curved portion of the proximal end 31 to move without contacting the guide plate 114 when the adjustment rod 34 is rotated to adjust the angular position of the deflector plate 28. Each guide plate 114 is preferably angled inwardly from the side wall of the casing 14 toward the flow path 20 so that a surface of the guide plate 114 is sloped in the direction of the flow path 20.

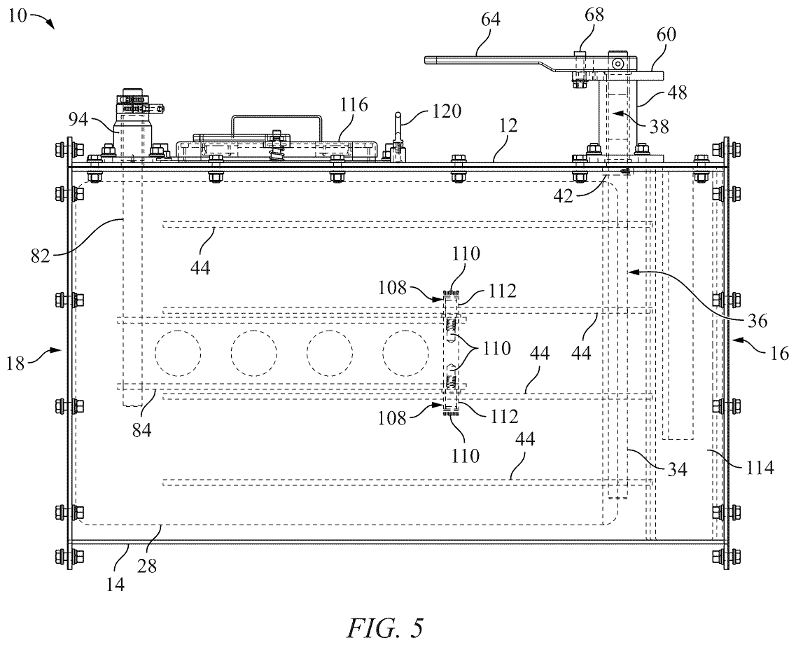

As best seen in FIGS. 5 and 12, each deflector plate assembly 26 further comprises a handle 64 attached to the second portion 38 of the adjustment rod 34 on the exterior side 24 of the cover plate 12. The handle 64 preferably has a portion that is sized and configured to allow a user to easily grab the handle 64 with their hand to move the handle 64. The handle 64 is configured to cause rotation of the adjustment rod 34 for adjustment of the angular position of the deflector plate 28 in response to manual rotation of the handle 64 by the user. The angular position of the deflector plate 28 may be adjusted relative to the flow path 20 to control the flow rate of the bulk material being conveyed through the chute 15.

In a preferred embodiment, as best seen in FIG. 12, each deflector plate assembly 26 further comprises a locking mount 48 attached to the exterior side 24 of the cover plate 12. The locking mount 48 may be configured to securely lock the handle 64 in place once the angular position of the deflector plate 28 has been set and also to provide structural support for the adjustment rod 34 to which the deflector plate 28 is attached. As best seen in FIG. 13, the locking mount 48 preferably comprises a cylindrical collar 54 having an elongated collar opening 56 that extends through the locking mount 48 between a first end 50 of the locking mount 48 and a second end 52 of the locking mount 48. The first end 50 of the locking mount 48 may comprise a mounting flange 58 configured to be attached to the exterior side 24 of the cover plate 12 using bolts or similar fasteners. The second end 52 may comprise a locking plate 60 to which the handle 64 may be fastened to securely retain the handle 64 in a rotationally fixed position relative to the locking plate 60. The second portion 38 of the adjustment rod 34 extends into the elongated collar opening 56 and preferably extends through the collar opening 56 and out of the collar opening 56 at the second end 52 of the locking mount 48. A collar 42 may be attached to the adjustment rod 34 at a position on the interior side 22 of the cover plate 12 to prevent the adjustment rod 34 from sliding in an outward axial direction through the collar opening 56.

As shown in FIG. 12, the locking mount 48 may include a pair of bushings 78 disposed within the elongated collar opening 56 at opposing ends 50 and 52 of the locking mount 48 to provide bearing surfaces in which the adjustment rod 34 can rotate in response to rotation of the handle 64 to adjust the angular position of the deflector plate 28 attached to the adjustment rod 34. The two bearing surfaces of the bushings 78 provide two support areas that are spaced apart from each other to provide structural support to the second portion 38 of the adjustment rod 34. This configuration may provide sufficient structural support for the adjustment rod 34 since a distal end of the first portion 36 of the adjustment rod 34 to which the deflector plate 28 is attached is preferably not mechanically attached to any other portion of the device 10 or the chute 15. In an alternative embodiment, the distal end of the first portion 36 of the adjustment rod 34 may be supported by an additional bearing installed within a side wall of the casing 14 or within another wall of the chute 15.

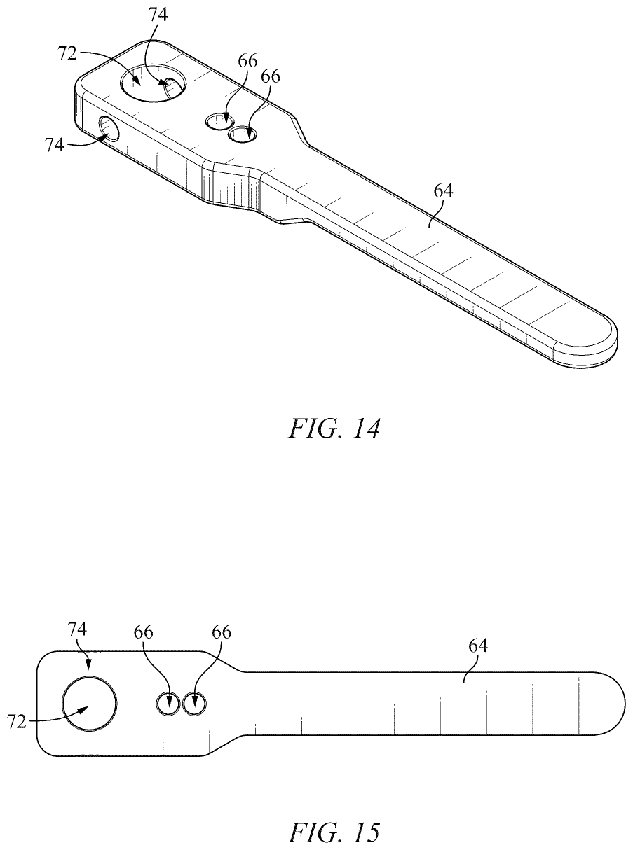

The handle 64 may be attached to a proximal end of the second portion 38 of the adjustment rod 34. FIGS. 14 and 15 show one embodiment of a handle 64 that may be utilized. In a preferred embodiment, to allow attachment of the handle 64 to the adjustment rod 34, the handle 64 may have an attachment opening 72 into which the proximal end of the adjustment rod 34 may be inserted. The handle 64 may also have a pin opening 74 extending through the handle 64 in a direction perpendicular to the attachment opening 72 and passing through the attachment opening 72. As best seen in FIG. 12, after inserting the proximal end of the adjustment rod 34 into the attachment opening 72 of the handle 64, a pin 76 may then be inserted through the pin opening 74 to attach the handle 64 to the adjustment rod 34. The pin 76 may then be fastened to the handle 64 to securely fasten the handle 64 to the adjustment rod 34.

In a preferred embodiment, as best seen in FIG. 12, the fastener 68 for selectively retaining the handle 64 in a rotationally fixed position may be a threaded fastener having an elongated shank 70. In this embodiment, the locking plate 60 may have a generally circular shape and a plurality of fastener openings 62 extending through the locking plate 60, and the handle 64 may have one or more handle openings 66 extending through the handle 64. The one or more handle openings 66 and each of the plurality of fastener openings 62 are sized to receive the elongated shank 70 of the fastener 68 therein, and the elongated shank 70 of the fastener 68 is configured to retain the handle 64 in a rotationally fixed position when the elongated shank 70 is inserted through both of a respective one of the handle openings 66 and a respective one of the plurality of fastener openings 62. The fastener 68 may include a head configured for engagement with a tool for installing and removing the fastener 68 and a threaded nut for retaining the fastener 68 in place. Once the fastener 68 is installed, the handle 64 may not rotate relative to the locking plate 60, which also retains the adjustment rod 34 in a rotationally fixed position and thus retains the deflector plate 28 in a fixed angular position relative to the flow path 20. Alternatively, fastener 68 may not be threaded and may be retained in place using a pin, clip, or other similar type of fastening mechanism.

In a preferred embodiment, as best seen in FIG. 12, the locking plate 60 includes two curved rows of fastener openings 62, a first one of which is disposed along a peripheral edge of the circular locking plate 60 and a second one of which is disposed concentrically inward from the first row and nearer to the collar opening 56 of the locking mount 48. In this embodiment, the two rows of fastener openings 62 are offset from each other, and the handle 64 has two corresponding handle openings 66. Each of the handle openings 66 corresponds to one of the two rows of fastener openings 62 and is configured to align with each of the fastener openings 62 in one of the rows of fastener openings 62 as the handle 64 is rotated. When one of the handle openings 66 is aligned with a fastener opening 62, the other handle opening 66 will not be aligned with a fastener opening 62. Thus, only one of the handle openings 66 is utilized at any given time, and the handle opening 66 utilized depends on the row in which the fastener opening 62 that is appropriate for a desired position of the deflector plate 28 is disposed. This configuration of multiple offset rows of fastener openings 62 allows for smaller intervals of angular adjustment of the deflector plate 28 and thus a greater degree of precision of control of the flow rate of the bulk material.

In a preferred embodiment, the flow control device 10 includes one or more handles 64 configured only for manual adjustment of the one or more deflector plates 28 and does not include any type of automated or remote actuating devices for adjusting the position of the deflector plates 28. Thus, all adjustments are preferably performed by a user manually rotating the handles 64 to adjust the angular positions of each respective one of the deflector plates 28 and then locking the handles 64 in the desired position to maintain the position of the deflector plates 28. Such a device 10 is cost-effective and simple both to manufacture and to retrofit to existing chutes 15.

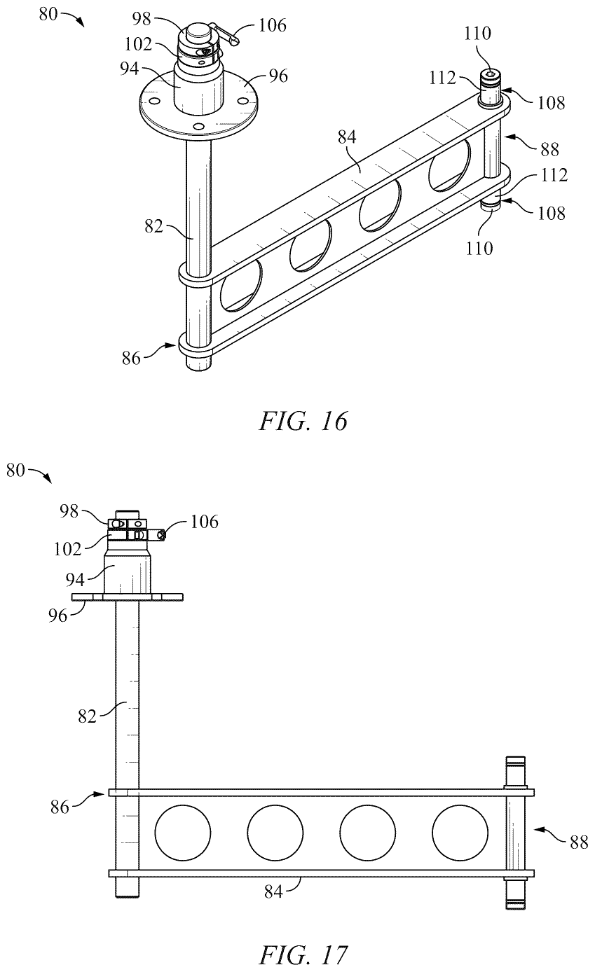

In a preferred embodiment, to provide additional structural support to the one or more deflector plates 28 to maintain a fixed angular position of the deflector plates 28, the flow control device 10 further comprises a deflector plate support assembly 80 for each deflector plate 28. FIGS. 16 and 17 show a deflector plate support assembly 80 detached from the device 10. The deflector plate support assembly 80 comprises a rotatable support rod 82 attached to the cover plate 12 and a support arm 84 having a first end 86 and an opposing second end 88. The support arm 84 is preferably disposed in a position that is generally perpendicular to the support rod 82. The first end 86 of the support arm 84 is fixedly attached to the support rod 82, and the second end 88 of the support arm 84 is slidably attached to the deflector plate 28 so that an attachment point between the support arm 84 and the deflector plate 28 can move in a slidable manner when the angular position of the deflector plate 28 is adjusted. The slidable attachment also maintains the attachment point between the support arm 84 and the deflector plate 28 regardless of the angular position of the deflector plate 28 within a range of angular positions. At least a portion of the support rod 84 is disposed on the interior side 22 of the cover plate 12 in a position in which the support rod 84 is generally perpendicular to the cover plate 12.

In a preferred embodiment, the support rod 84 is attached to the cover plate 12 by a bearing assembly 90 configured to allow rotation of the support rod 82 within a support rod opening 92 that extends through the cover plate 12. The bearing assembly 90 comprises a bearing collar 94 attached to the exterior side 24 of the cover plate 12. The bearing collar 94 has a bearing collar opening 95 that preferably extends entirely through the bearing collar 94. The bearing collar opening 95 is aligned with the support rod opening 92 when the bearing collar assembly 90 is installed. The support rod 82 extends through the support rod opening 92 in the cover plate 12 and is received within the bearing collar opening 95 in the bearing collar 94 so that the bearing collar 94 surrounds at least a portion of the support rod 82. The bearing collar 94 preferably comprises a flange 96 configured to attach the bearing collar 94 to the exterior side 24 of the cover plate 12 using bolts or similar types of fasteners.

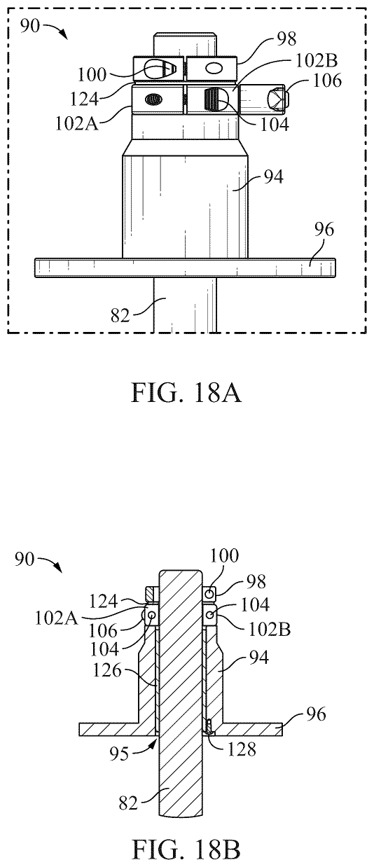

In a preferred embodiment, as best seen in FIGS. 18A and 18B, the bearing assembly 90 of the deflector plate support assembly 80 further comprises a collar clamp 98, a retaining device 102 configured to prevent rotation of the support rod 82, a thrust washer 124 disposed between the collar clamp 98 and the retaining device 102, and a sleeve bearing 126 disposed within the bearing collar opening 95. Each of these components are preferably positioned at an end of the support rod 82 that is disposed on the exterior side 24 of the cover plate 12. The sleeve bearing 126 provides a bearing surface on which the support rod 82 can rotate. The sleeve bearing 126 may be retained in place by a set screw 128 or similar type of fastener. The collar clamp 98 is sized to fit around the support rod 82 and is not directly attached to the bearing collar 94 or retaining device 102. The collar clamp 98 has a circular opening to receive the support rod 82 therein and preferably has a break in the ringed structure to allow the collar clamp 98 to be fitted around the support rod 82. The collar clamp 98 may have aligned openings on opposing sides of the break, which may be configured to receive a fastener 100 therein for tightening the collar clamp 98 onto the support rod 82. The fastener 100 is preferably threaded, and at least one of the aligned openings has threads that are compatible with the threads of the fastener 100 so that the fastener 100 may be used to fixedly clamp the collar clamp 98 onto the support rod 82 so that the support rod 82 cannot rotate within the collar clamp 98. Once clamped, the collar clamp 98 prevents axial movement of the support rod 82 in an inward axial direction, though the collar clamp 98 may allow axial movement of the support rod 82 in an outward axial direction.

The retaining device 102 preferably comprises two halves 102A and 102B configured to surround the support rod 82 and two fasteners 104 configured to clamp the retaining device 102 to the support rod 82. The first half 102A may be fixedly attached to the bearing collar 94 by welding or by a similar type of fixed attachment, and the second half 102B may be removable from the assembly 90. The retaining device 102 may have two pairs of aligned openings with each pair being configured to receive a threaded fastener 104 therein for fastening the two halves 102A and 102B to each other. In a preferred embodiment, one of the fasteners 104 has a handle 106 attached to the fastener 104 to allow manual tightening or loosening of the fastener 104 using the handle 106 to rotate the fastener 104 rather than using a separate tool. When at least one of the fasteners 104 is loosened, the support rod 82 may rotate within the retaining device 102 to allow adjustment of the angular position of the deflector plate 28. The thrust washer 124 reduces friction between the collar clamp 98 and the retaining device 102 when the support rod 82 is rotated, which causes the collar clamp 98 to also rotate relative to the retaining device 102. When the fasteners 104 are tightened, the retaining device 102 prevents rotation of the support rod 82 within the bearing collar opening 95 in the bearing collar 94. Thus, one or both of the fasteners 104 can be loosened to allow the angular position of the deflector plate 28 to be adjusted, which causes rotation of the support rod 82 within the bearing collar 94. Once the deflector plate 28 is set in a desired angular position and the handle 64 is secured in place to prevent angular movement of the deflector plate 28, the fasteners 104 can be tightened to retain the support rod 82 in a rotationally fixed position, which maintains the attachment point between the support arm 84 and the deflector plate 28 in a fixed position to provide structural support to the deflector plate 28. Thus, when bulk material contacts the interior side 30 of the deflector plate 28, the support arm 84 exerts a counteracting force on the exterior side 32 of the deflector plate 28 to support the deflector plate 28 in its set angular position, which helps to minimize forces exerted on the adjustment rod 34, handle 64, and locking mount 48. When in use, the attachment point between the support arm 84 and the deflector plate 28 within the elongated slots 46 may provide a counteracting force due to both the adjustment rod 34 and the support rod 82 being locked in rotationally fixed positions. In an alternative embodiment, as best seen in FIG. 19, the flow control device 10 may optionally not include deflector plate support assemblies 80, which may not be necessary, particularly in applications utilizing smaller chutes 15 or having low flow rates that do not cause the bulk material to exert substantial force on the deflector plates 28. In this case, the support rod openings 92 in the cover plate 12 may be covered by a blind flange 122 to prevent bulk material or dust produced by the bulk material from discharging through openings 92.

To facilitate slidable attachment of the support arm 84 to the deflector plate 28, the deflector plate 28 preferably comprises a lateral extension plate 44 having an elongated slot 46 therein, as best seen in FIG. 10. In a preferred embodiment, the deflector plate 28 has a plurality of lateral extension plates 44 extending in an outward direction from the exterior side 32 of the deflector plate 28, and two adjacent lateral extension plates 44 each have an elongated slot 46 therein. In this embodiment, the second end 88 of the support arm 84 is slidably attached to the deflector plate 28 by a pair of pins 108, each of which is slidably disposed within a respective one of the elongated slots 46 so that each pin 108 can slide along and within the entire length of the slot 46. As best seen in FIG. 17, each of the pins 108 preferably extends in opposing directions, including one pin 108 extending from the support arm 84 in an upward direction and one pin 108 extending in a downward direction. The support arm 84 may have a width that is sized to fit between adjacent lateral extension plates 44 in a position in which each of the pins 108 is disposed within one of the elongated slots 46. In a preferred embodiment, as best seen in FIG. 5, each pin 108 may comprise a threaded fastener 110 with at least a portion of one end of the threaded fastener 110 surrounded by a flange screw bearing 112. The threaded fastener 110 may facilitate attachment and removal of the pins 108 during installation or removal of the deflector plate support assembly 80. The flange screw bearing 112 may protect the fastener 110 and provide an outer surface of the pin 108 that contacts edge surfaces of the elongated slots 46. As the pins 108 slide within slots 46, the flange screw bearing 112 may rotate on the fastener 110 to facilitate sliding of the pins 108 within the slots 46.

In a preferred embodiment, as best seen in FIG. 10, each of the lateral extension plates 44 may be fixedly attached to the adjustment rod 34 and extend entirely around a circumferential perimeter of the adjustment rod 34. The curved portion at the proximal end 31 of the deflector plate 28 may be attached to each of the lateral extension plates 44 to provide structural support to the curved portion of the deflector plate 28 and to allow the curved portion to have a larger diameter.

FIGS. 7A-7E illustrate two flow control devices 10 installed in series within a section of a vertical chute 15 with deflector plates 28 at varying angular positions. It should be understood that additional devices 10 may be utilized in a chute 15 or, alternatively, only a single device 10 may be utilized. As shown in FIGS. 7A-7D, each device 10 preferably includes two opposing deflector plates 28 installed along opposing side walls of the casing 14 or other wall structure of the chute 15. In this embodiment, each flow control device 10 includes corresponding opposing deflector plate assemblies 26, including all associated components of each deflector plate assembly 26, and, optionally, corresponding opposing deflector plate support assemblies 80, including all associated components of each deflector plate support assembly 80. Alternatively, as shown in FIG. 7E, the device 10 may have only a single deflector plate 28, in which case the adjustment rod opening 40 and the support rod opening 92 in the cover plate 12 at the location opposite the single deflector plate 28 may be covered by a blind flange 122 to prevent bulk material or dust produced by the bulk material from discharging through openings 40 and 92.

FIG. 7A shows all of the deflector plates 28 in a maximum open position. Even in this position, the devices 10 may reduce the flow rate to a degree since the open position of the deflector plates 28 reduces the diameter of the flow path 20 through the device 10 to an extent. FIG. 7B shows all of the deflector plates 28 generally in the same angular position in which each deflector plate 28 has been adjusted to be angled slightly inward. This position will reduce the flow rate to a greater extent than the maximum open position. FIG. 7C shows one deflector plate 28 of each device 10 generally in the same angular position and one deflector plate 28 of each device 10 in a maximum open position. The angled and open positions of the adjacent flow control devices 10 are staggered to force the bulk material to flow in a back-and-forth zigzagging flow path 20 as the material flows through adjacent devices 10. Additional devices 10 may be added in series to continue the zigzagging flow path 20 to further reduce the flow rate of the bulk material. Thus, as bulk material flows through the upper device 10 shown in FIG. 7C, the material will contact the angled deflector plate 28, which will direct the material in a direction toward one side of the flow path 20. As the bulk material continues to fall and then enters the lower device 10, the material will then contact the angled deflector plate 28, which will then direct the material in an opposite direction toward an opposite side of the flow path 20, thereby slowing the flow rate. FIG. 7D shows an additional variation with the upper device 10 having deflector plates 28 angled slightly inward at similarly angled positions, and the lower device 10 has one deflector plate 28 in the maximum open position and the opposing deflector plate 28 in a position in which the deflector plate 28 is angled inwardly into the flow path 20 to a greater extent than the deflector plates 28 in the upper device 10. FIG. 7E shows deflector plates 28 in a similar zigzagging flow path 20 as that of FIG. 7C but with the deflector plates 28 angled inwardly into the flow path 20 to a greater extent and with the opposing deflector plates 28 of each device 10 being removed.

FIG. 7F illustrates two flow control devices 10 installed in series within a section of a chute 15 that is disposed at an inclined angle of approximately 45 degrees from a vertical position. Depending on the type of bulk material being conveyed, chutes 15 at varying angles of inclination may be utilized. Thus, it should be understood by one of skill in the art that angles of inclination of conveyance chutes may vary significantly from a vertical plane in some applications. For instance, some types of bulk materials may fluidize and may thus be capable of flowing within a chute at an inclined angle as low as approximately 10 degrees from a horizontal plane. In some cases, air slide conveyor systems may be utilized to provide assisted gravity flow of bulk materials in chutes with low inclination angles. In cases utilizing inclined chutes 15, the present flow control devices 10 may be installed within the inclined chute 15 to control the flow of bulk material within the chute 15. In some facilities that handle bulk materials, inclined chutes may sometimes be installed at an improper angle for handling certain materials, or an existing chute installed to handle a particular type of bulk material may be used at other times to handle a different type of bulk material having different flow characteristics that may require a different inclination angle. However, in many cases it may be cost-prohibitive to modify the angle of inclination of an existing chute or to install a new chute at the proper angle. In such cases, one or more of the present flow control devices 10 may be retrofitted to an existing inclined chute 15 to provide better control of the flow of bulk material within the chute 15, which may provide a low-cost alternative to re-installing a new or existing chute.

It should be understood by one of skill in the art that one or more respective deflector plates 28 of one or more respective flow control devices 10 may be set at varying angular positions and still fall within the scope of the present disclosure. The number of flow control devices 10 utilized with the system, the spacing of devices 10 within the chute 15, and the angular positions of the one or more deflector plates 28 utilized with the system, as well as the angle of incline of the chute 15, may all be adjusted based on numerous factors, including, but not limited to, the type and characteristics of the bulk material being conveyed, the volume of material being conveyed, the diameter of the chute 15, the size of the deflector plates 28, and the desired flow rate of the bulk material.

The implementations set forth in the foregoing description do not represent all implementations consistent with the subject matter described herein but are examples consistent with the disclosed subject matter. Although variations have been described in detail above, other modifications or additions may be possible. It is understood that one of skill in the art would appreciate these various implementations and variations as falling within the scope of the present disclosure.

What is claimed is:

1. A flow control device comprising:
a cover plate having an interior side and an exterior side;
an adjustment rod extending through a first opening in the cover plate such that a
first portion of the adjustment rod is disposed on the interior side of the cover plate and a second portion of the adjustment rod is disposed on the exterior side of the cover plate, wherein the adjustment rod is rotatable within the first opening, wherein the adjustment rod is disposed in a position in which the adjustment rod is generally perpendicular to the cover plate;
a deflector plate attached to the first portion of the adjustment rod, wherein the deflector plate is disposed in a position in which the deflector plate is generally perpendicular to the cover plate;
a handle attached to the second portion of the adjustment rod, wherein the handle is configured to cause rotation of the adjustment rod for adjustment of the position of the deflector plate in response to manual rotation of the handle; and
a fastener configured to selectively retain the handle in a fixed position.

2. The flow control device of claim 1, further comprising a deflector plate support assembly, wherein the deflector plate support assembly comprises a support rod attached to the cover plate and a support arm attached to the support rod at a first end of the support arm, wherein at least a portion of the support rod is disposed on the interior side of the cover plate in a position in which the support rod is generally perpendicular to the cover plate, wherein an opposing second end of the support arm is slidably attached to the deflector plate.

3. The flow control device of claim 2, wherein the support rod is attached to the cover plate by a bearing assembly configured to allow rotation of the support rod.

4. The flow control device of claim 3, wherein the bearing assembly comprises a bearing collar attached to the exterior side of the cover plate, wherein the support rod extends through a second opening in the cover plate and is received within an opening in the bearing collar.

5. The flow control device of claim 2, wherein the deflector plate includes a lateral extension plate having an elongated slot therein, wherein the second end of the support arm is slidably attached to the deflector plate by a pin that is slidably disposed within the elongated slot.

6. The flow control device of claim 1, wherein the fastener includes an elongated shank, wherein the flow control device further comprises a locking mount attached to the exterior side of the cover plate, wherein the locking mount comprises a locking plate having a plurality of fastener openings extending through the locking plate, wherein the handle has a handle opening extending through the handle, wherein the handle opening and each of the plurality of fastener openings are sized to receive the elongated shank of the fastener therein, wherein the elongated shank of the fastener is configured to retain the handle in a fixed position when the elongated shank is inserted through both the handle opening and a respective one of the plurality of fastener openings.

7. The flow control device of claim 1, wherein the flow control device further comprises a locking mount attached to the exterior side of the cover plate, wherein the locking mount comprises a cylindrical collar having an elongated collar opening that extends through the locking mount between a first end of the locking mount and a second end of the locking mount, wherein the first end of the locking mount is attached to the exterior side of the cover plate, wherein the second portion of the adjustment rod extends through the elongated collar opening and out of the collar opening at the second end of the locking mount.

8. A flow control device comprising:
a rectangular enclosure having four sides, wherein the rectangular enclosure has an open inlet end and an opposing open outlet end, wherein one side of the four sides is defined by a cover plate having an interior side and an exterior side;
an opposing pair of adjustment rods each extending through a respective adjustment rod opening in the cover plate such that a first portion of each respective adjustment rod is disposed on the interior side of the cover plate and a second portion of each respective adjustment rod is disposed on the exterior side of the cover plate, wherein each of the pair of adjustment rods is rotatable within each respective adjustment rod opening, wherein each of the pair of adjustment rods is disposed in a position that is generally perpendicular to the cover plate;
an opposing pair of deflector plates each attached to the first portion of a respective one of the pair of adjustment rods, wherein each of the pair of deflector plates is disposed in a position that is generally perpendicular to the cover plate;
an opposing pair of handles each attached to the second portion of a respective one of the pair of adjustment rods, wherein each respective one of the pair of handles is configured to cause rotation of a respective one of the pair of adjustment rods for adjustment of the position of a respective one of the pair of deflector plates in response to manual rotation of a respective one of the pair of handles; and
a pair of fasteners each configured to selectively retain a respective one of the pair of handles in a fixed position.

9. The flow control device of claim 8, wherein each respective one of the pair of deflector plates has a generally flat surface facing inwardly toward a flow path extending between the pair of deflector plates and through the rectangular casing from the open inlet end to the open outlet end.

10. The flow control device of claim 8, wherein each respective one of the pair of deflector plates has an inwardly facing side that faces toward a flow path extending between the pair of deflector plates and through the rectangular casing from the open inlet end to the open outlet end, wherein each respective one of the pair of handles is configured to adjust an angle of a respective one of the pair of deflector plates relative to the flow path in response to manual rotation of a respective one of the pair of handles.

11. The flow control device of claim 8, further comprising a first and a second deflector plate support assembly, wherein each deflector plate support assembly comprises a support rod attached to the cover plate and a support arm attached to the support rod at a first end of the support arm, wherein the support rod is disposed on the interior side of the cover plate in a position in which the support rod is generally perpendicular to the cover plate, wherein an opposing second end of the support arm is slidably attached to a respective one of the pair of deflector plates.

12. The flow control device of claim 11, wherein the support rod of each deflector plate support assembly is attached to the cover plate by a bearing assembly configured to allow rotation of the support rod.

13. The flow control device of claim 12, wherein the support rod of each deflector plate support assembly extends through a support rod opening in the cover plate, wherein the bearing assembly comprises a bearing collar attached to the exterior side of the cover plate.

14. The flow control device of claim 11, wherein each respective one of the pair of deflector plates includes a lateral extension plate having an elongated slot therein, wherein the second end of the support arm of each deflector plate support assembly is slidably attached to a respective one of the pair of deflector plates by a pin that is slidably disposed within the elongated slot.

15. The flow control device of claim 8, wherein each respective one of the pair of fasteners includes an elongated shank, wherein the flow control device further comprises a pair of locking mounts each attached to the exterior side of the cover plate, wherein each respective one of the pair of locking mounts comprises a locking plate having a plurality of fastener openings extending through the locking plate, wherein each respective one of the pair of handles has a handle opening extending through the handle, wherein the handle opening and each of the plurality of fastener openings are sized to receive the elongated shank of the fastener therein, wherein the elongated shank of the fastener is configured to retain the handle in a fixed position when the elongated shank is inserted through both the handle opening and a respective one of the plurality of fastener openings.

16. The flow control device of claim 8, wherein the flow control device further comprises a pair of locking mounts each attached to the exterior side of the cover plate, wherein each respective one of the pair of locking mounts comprises a cylindrical collar having an elongated collar opening that extends through the locking mount between a first end of the locking mount and a second end of the locking mount, wherein the first end of the locking mount is attached to the exterior side of the cover plate, wherein the second portion of the adjustment rod extends through the elongated collar opening and out of the collar opening at the second end of the locking mount.
